(19) United States
(12) Patent Application Publication
(10) Pub. No.: US 2017/0351042 A1
(43) Pub. Date: Dec. 7, 2017

(54) OPTICAL WAVEGUIDES IN CIRCUIT BOARD SUBSTRATES

(71) Applicant: International Business Machines Corporation, Armonk, NY (US)

(72) Inventors: Eric J. CAMPBELL, Rochester, MN (US); Joseph KUCZYNSKI, North Port, FL (US); Timothy J. TOFIL, Rochester, MN (US)

(21) Appl. No.: 15/173,328

(22) Filed: Jun. 3, 2016

(51) Int. Cl. G02B 6/42; G02B 6/12; G02B 6/122; G02B 6/138

(52) U.S. Cl. CPC G02B 6/428; G02B 6/4257; G02B 6/138; G02B 6/12004; G02B 6/122; G02B 6/1221

(57) ABSTRACT

A circuit board substrate includes a reinforcing element embedded in a resin material. The reinforcing element includes an optical waveguide. The circuit board substrate can be used in electronic devices as a printed circuit board or the like. A circuit board substrate for use in electronic devices can be formed by embedding a reinforcing element comprising an optical waveguide in a resin. The optical waveguide can be coupled to optical signal transmission and reception elements to transmit an optical signal through the reinforcing element. The optical waveguide may be an optical fiber or the like in some examples.

### BACKGROUND

The present disclosure concerns circuit boards including optical waveguides, such as optical fibers, for transmission of optical signals.

The data transmission requirements in electronic devices, such as servers, routers, and high-bandwidth computing systems, are continuously increasing. As such, there is a need for increasing data transmission rates in these devices. So called, “optical backplane” systems that transmit data via optical signals have been incorporated into electronic devices and have shown the potential for higher interconnect density and higher data rates per channel as compared to existing data transmission methods. Optical transmission systems are considered to have several advantages over existing electrical signal transmission methods, such as increased bandwidth and lower signal cross-talk. However, in general, optical signal transmission requires incorporating optical fibers or waveguides into electronic devices, which may be difficult without also increasing the size of electronic devices that incorporate signal transmission over optical fibers. Therefore, there is need to incorporate optical waveguides for signal transmission into electronic devices to improve data transmission throughput without increasing device size.

### SUMMARY

According to one embodiment, a circuit board comprises a resin material and a reinforcing structure embedded in the resin material and including an optical waveguide.

According to another embodiment, an electronic device comprises a circuit board including a resin material and a reinforcing structure embedded in the resin material and including an optical waveguide. The optical waveguide is coupled to an optical signal transmission module on a first end and an optical signal receiver module on a second end.

According to still another embodiment, a method comprises forming a circuit board substrate by embedding a reinforcing element in a resin material. The reinforcing element includes an optical waveguide. In some examples, the optical waveguide can comprise an optical fiber.

### BRIEF DESCRIPTION OF THE DRAWINGS

FIG. 1 depicts a circuit board having a reinforcing component comprising an optical waveguide.

FIG. 2A depicts plan view of an electronic device including a circuit board having a reinforcing element comprising an optical waveguide.

FIG. 2B depicts a cross-sectional view of an electronic device including a circuit board having a reinforcing element comprising an optical waveguide.

FIG. 3 depicts another electronic device including a circuit board having a reinforcing element comprising an optical waveguide.

FIG. 4 depicts a cross-sectional view of a reinforcing element that is an optical waveguide.

FIG. 5 depicts aspects of a method according to an embodiment.

### DETAILED DESCRIPTION

A great variety of circuit board types (commonly referred to as “printed circuit boards” or “PCBs”) are known. In general, a circuit board comprises a substrate formed of reinforcing material, such as one or more layers of cloth, fiber mesh, or paper, and a resin material in which the reinforcing material is embedded. In particular, glass fibers are often used as the reinforcing material. The resin material can be a thermosetting resin or other curable resin that is initially oligomeric or low molecular weight material which hardens after application, but is necessarily not limited to such materials. In particular, epoxy resins are often employed as the resin material in printed circuit boards, but other resin materials include phenolic resins, polyester resins, polyimide resins, polytetrafluoroethylene resins, and polyphenylene ether resins.

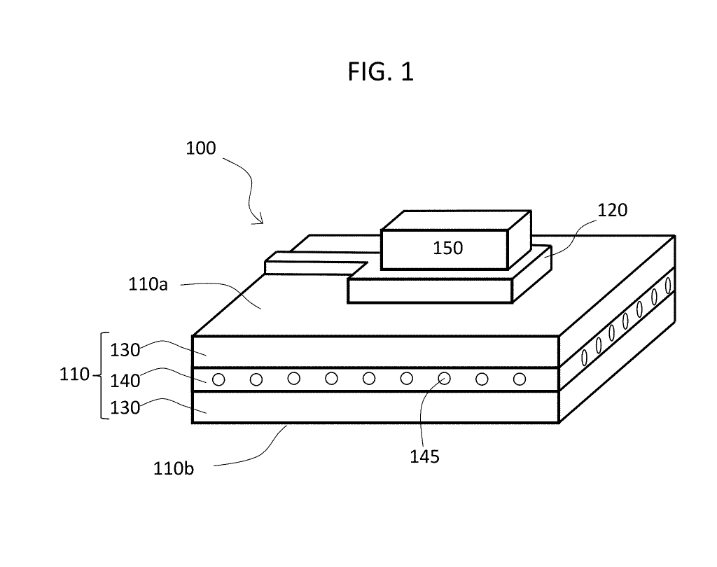

FIG. 1 depicts a circuit board according to an embodiment of the present disclosure. As depicted, circuit board 100 comprises a substrate 110 having a reinforcing element 140 that includes an optical waveguide 145. The reinforcing element 140 is embedded within substrate 110 by a resin material 130. The optical waveguide 145 can be used for carrying an optical signal. In this example embodiment, the optical waveguide 145 is an optical fiber and, in description of certain example embodiments, may be referred to as “optical fiber 145.” A conductive layer 120 is disposed on a first surface 110a of substrate 110. A device component 150 is also disposed on the first surface 110a via the conductive layer 120.

The conductive layer 120 depicted in FIG. 1 has already been patterned into a circuit trace or wiring pattern. In this example, conductive layer 120 is copper and is the remaining portion of a metal film previously disposed over the entirety of first surface 110a. The metal film has been patterned using a photolithographic process and a wet etching technique (e.g., a ferric chloride etchant). In some embodiments, a conductive layer 120 may also be disposed on a second surface 110b of substrate 110. A conductive layer 120 or conductive layers 120 may also be disposed within substrate 110. For example, a wiring pattern (or a portion thereof) formed by a conductive layer 120 may be embedded within resin material 130 in addition to or instead of being disposed on the first surface 110a.

Formation of the conductive layer 120 may include lamination of metal foils, electroplating steps, electroless deposition steps, or combinations of these processes. The conductive layer 120 can be patterned in a subtractive process (e.g., photolithographic processing with chemical etching of an unprotected metal film), an additive process (deposition/plating of conductive material on particular portions of the substrate 110), or combinations of subtractive and additive processes. Copper is typically used in printed circuit boards, but other conductive metals or materials can be used as the conductive layer 120.

The resin material 130 may be, for example, epoxy resin, phenolic resin, acrylate resin, methacrylate resin, polyimide resin, a polytetrafluoroethylene resin, or a polyphenylene ether resin (polyphenylene oxide). Resin material 130 can be thermosetting, thermally curable, or an otherwise setting or curable resin that may be initially applied to reinforcing element 140 as a fluidic or flowable precursor that cures or hardens after application. For example, resin material 130 may be applied to reinforcing element 140 as an oligomeric liquid, and then pressed between heated platens to solidify the applied liquid by curing to form the resin material 130 (and substrate 110). Curing in this context includes crosslinking reactions and/or additional polymerization. Components such as initiators, binders, catalysts, fillers may be included into resin material 130 to promote curing or to alter properties of the resin material 130. In other examples, reinforcing material 140 may be placed in a mold into which a precursor to resin material 130 is supplied. The precursor material can then be hardened by heating and/or exposure to light (photocuring) or other radiation (e.g., electron beam curing). Some types of resin material 130 may be melt-processable such that resin material 130 may be applied as a heated melt to reinforcing element 140 and then allowed to cool to a solid substrate 110. In other examples, a substantially solid resin material 130 layer may be laminated or bonded to reinforcing element 140 using adhesive, thermal welding, solvent bonding, or other joining techniques.

A plurality of substrates 110 may be stacked, connected, or bonded together with or without a conductive layer 120 between each substrate 110. Electrical connections between conductive layers on different surfaces or at different levels of the substrate 110 can be made, for example, through interconnects (vias) extending through the substrate 110. The conductive layer 120 can be applied as, or otherwise formed into, a desired wiring pattern (electrical trace) for use in connecting device component(s) 150 that are to be mounted on the substrate 110 via the conductive layer 120 or otherwise.

A device component 150 can be eventually mounted on the conductive layer 120 via soldering, adhesive, conductive paste or the like. As depicted in FIG. 1, component 150 is disposed on the conductive layer 120, but device component 150 may also be disposed directly on the first surface 110a without conductive layer 120 being interposed. Device component 150 may be, without limitation, a packaged integrated circuit or a discrete circuit component, such as a diode, resistor, capacitor, or transistor. Other items, such as cooling fans, heatsinks, component mounts, connectors, or the like, may also be attached or connected to substrate 110. A plurality of device components 150 may be mounted on substrate 110. Some or all device components 150 may be electrically connected to conductive layer 120 or particular portions thereof. Device components 150 may be mounted on both first surface 110a and second surface 110b.

Typically, several different device components will be mounted on, or otherwise attached to, a printed circuit board. For example, semiconductor chips (packaged integrated circuits) of different functions (e.g., processors, memory modules, microelectromechanical machines) might be soldered to the substrate 110 and electrically connected to wiring patterns formed by conductive layer 120.

Mounting the device components 150 to the substrate 110 may be performed using solder, adhesive, conductive paste, wire bonding, pin connectors, through-hole technology, surface-mount technology, and the like. Mechanical and electrical connection of device components 150 to the circuit board 100 may be achieved by the same or different means. For example, a device component 150 may be mechanically affixed to first surface 110a with adhesive, but electrically connected to the conductive layer 120 by wire bonding or other means. In other examples, a device component 150 may be both mechanically and electrically connected by soldering, such as by use of a ball grid array (BGA) technique. The device component 150 may also be mounted on a pad or landing portion formed by the conductive layer 120 without being electrically connected to the pad or landing portion of the conductive layer 120.

In printed circuit boards, the reinforcing materials are often woven glass fibers, but may also be paper, cloth, or unwoven (matted) glass fibers, and combinations of these materials. The reinforcing materials in existing printed circuit boards are generally intended to provide structural rigidity and dimensional stability over expected device operating temperatures. Some other considerations relate to the required electrical insulating characteristics (dielectric constant) of the circuit board and the degree to which the circuit board is expected to be fire resistant.

As depicted in FIG. 1, a reinforcing element 140 of printed circuit board 100 includes optical waveguide 145 as an internal portion of the substrate 110. The reinforcing element 140 can include additional materials and objects other than optical waveguide 145, or reinforcing element 140 may consist of only the optical waveguide 145. For example, when optical waveguide 145 is an optical fiber, a plurality of optical fibers could be interwoven with other fibers to form a mesh or a cloth-like material. Also, a mesh or a cloth-like material could be formed using only optical fibers (a plurality of optical waveguides 145). In some embodiments, optical waveguide 145 in reinforcing element 140 can comprise several layers of optical fiber (or cloth-like materials formed using optical fibers).

Also, other reinforcing materials known in the art (e.g., papers, cloths, chopped strand mats) may be incorporated into substrate 110 as distinct layers or substrate portions laminated with the reinforcing element 140. Additionally, as noted, reinforcing element 140 may itself comprise other reinforcing materials other than optical waveguide 145. That is, reinforcing materials other than optical waveguide 145 can be included in reinforcing element 140, so long as at least one optical waveguide 145 is included in reinforcing element 140.

A plurality of optical waveguides 145 may be incorporated into reinforcing element 140. These optical waveguides 145 can be incorporated within substrate 110 with a substantially even distribution throughout (as depicted in FIG. 1) or may be included only in certain discrete portions of the substrate 110. For example, optical waveguides 145 might be incorporated only in those portions of the substrate 110 in which a predetermined printed circuit board 100 design indicates optical signal transmission will be required or permitted.

Furthermore, while the optical waveguide 145 appears in FIG. 1 as a discrete, unitary element, this is for explanatory convenience, and each depicted optical waveguide 145 may also be a bundle or other agglomeration of individual optical fibers in addition to a single optical fiber. For example, each “thread” of a cloth-like or mesh reinforcing element 140 may be a single optical fiber or a bundle of several optical fibers.

It should also be noted that figures in this disclosure are schematic and the depicted elements are not necessarily drawn to scale. As such, the substrate 110 may have different proportions of resin material 130 and reinforcing element 140 than has been depicted in the figures. Likewise, optical waveguide 145 may comprise any desirable volume fraction of reinforcing element 140 (or substrate 110) greater than zero. Additionally, it is not necessary for the reinforcing element 140 to be positioned between equally sized resin material 130 portions in substrate 110. The reinforcing element 140 is not required to be on a centerline of substrate 110 in a thickness direction and may be offset from the thickness centerline towards either first surface 110a or second surface 110b. Likewise, it is not necessary for reinforcing element 140 (or optical waveguide 145) to be disposed parallel to either first surface 110a or second surface 110b. While reinforcing element 140 is depicted as spanning from edge to edge of substrate 110, this is not required and reinforcing element 140 may be spaced from the outer edges of substrate 110. Furthermore, while reinforcing element 140 is depicted as a single, unitary layer within substrate 110, resin material 130 may penetrate through openings in the reinforcing element 140. For example, when reinforcing element 140 comprises a mesh of optical fibers, resin material 130 (or other resin material) may fill openings in the mesh. Note also, the optical waveguide 145 need not be laid out parallel or perpendicular to the edges of the substrate 110. That is, if substrate 110 has rectangular planar shape (in an overhead/plan view), the optical waveguide 145 in reinforcing element 140 is not required to span from edge to opposite edge of substrate 110, but may be placed on a diagonal or bias with respect to the edges of substrate 110. Furthermore, to the extent optical waveguide 145 can be bent or curved and still transmit an optical signal with tolerable transmission losses, optical waveguide 145 need not be laid out in a straight line and may be curved or bent. At least some bending of optical waveguide 145 would be expected to occur when it comprises a plurality of optical fibers that are woven or otherwise formed into reinforcing element 140 (which in some examples might be a cloth-like or mesh material).

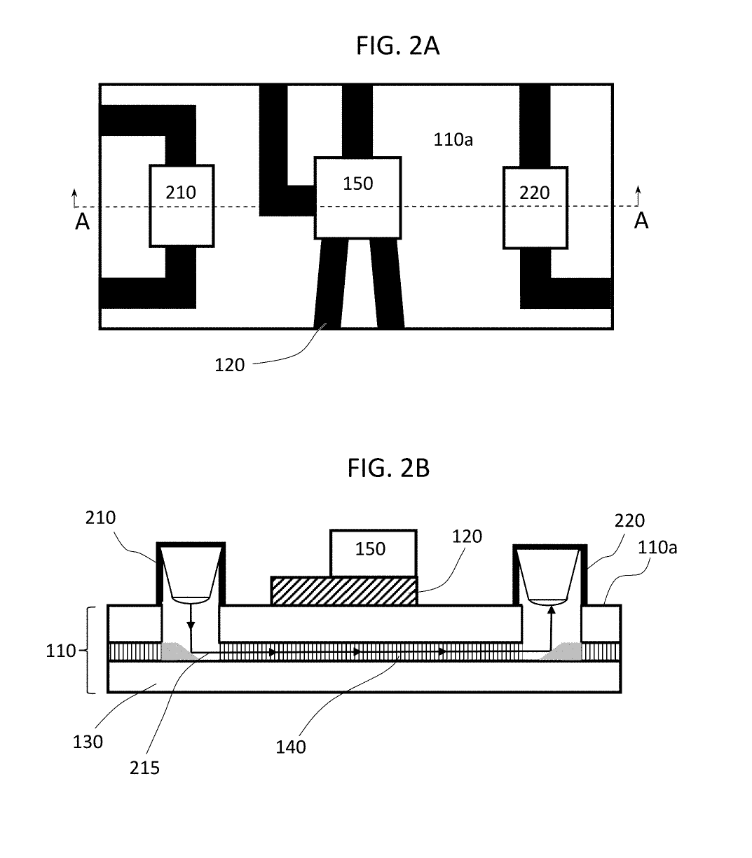

FIG. 2A depicts plan view of an example electronic device incorporating a circuit board including a reinforcing element having an optical waveguide. In FIG. 2A, a first surface 110a of a substrate 110 (as described above), includes a device component 150 mounted on conductive layer 120 formed in a wiring pattern. The wiring pattern is, in general, arbitrary and can be adjusted to accommodate device components 150 as needed. Also included on first surface 110a are an optical signal transmission element 210 and an optical signal reception element 220. Conductive layer 120 is depicted in FIG. 2A as being adjacent to elements 210 and 220, but this is an optional arrangement and any electrical requirements for elements might also be supplied by external wiring connections (not specifically depicted) made directly to the elements rather than through wiring patterns formed by conductive layer 120.

The optical signal transmission element 210 may include one or more light-emitting elements (e.g., light-emitting diodes, laser diode, or other light sources) and/or one or more couplings or connections to external light sources, which may be coherent or incoherent to any desired extent, monochromatic, polychromatic, or broad-spectrum to any desired extent, monomodal or polymodal to any desired extent, and convergent, divergent, or telecentric to any desired extent. For example, an incoming optical fiber bundle for carrying an optical signal from an external source may be coupled or otherwise connected to the optical signal transmission element 210. In other examples, the optical signal for transmission may be generated by a light-emitting element included in the optical signal transmission element 210. The optical signal transmission element 210 may include various lenses, mirrors, polarizers, filters, irises, prisms, or the like for directing, manipulating, or coupling light into the optical waveguide 145 within reinforcing element 140.

The optical signal reception element 220 may include a light-receiving element (e.g., photodiode) and/or a coupling or connection to an external light reception element. For example, an outgoing optical fiber bundle for carrying an optical signal to an external light receiving element may be coupled or otherwise connected to the optical signal reception element 220. In other examples, the optical signal reception element 220 may incorporate light receiving elements that convert received light into electrical signals. The optical signal reception element 220 may include various lenses, mirrors, polarizers, filters, irises, prisms, or other reflective, refractive, or diffusive elements for directing or manipulating light as needed.

In some examples, optical signal transmission element 210 may be referred to optical signal transmitter 210 and optical signal reception element 220 may be referred to as optical signal receiver 220. In some further examples, operations of optical signal transmitter 210 and optical signal receiver 220 may be integrated or combined into a single housing or component referred to as an optical signal transceiver.

The number of paired optical signal transmission elements 210 and optical signal reception elements 220 is not limited and, in general, a transmitter/receiver pair may operate using one coupled optical waveguide 145. When reinforcing element 140 includes a plurality of optical waveguides 145, then, in principle, a different optical signal 215 can be carried on each optical waveguide 145 allowing for a corresponding plurality of transmitter/receiver pairs. In practice, practical spacing requirements between adjacent transmission and/or reception elements might limit the number of transmitter/receiver pairs. Additionally, depending on the spacing between adjacent optical waveguides 145 in the reinforcing element, in some examples, two or more adjacent optical waveguides 145 may be used to carry an optical signal 215 between a transmitter/receiver pair. Use of multiple optical waveguides 145 to carry each optical signal provides improved fault tolerance in some cases.

FIG. 2B depicts a cross-sectional view of the electronic device depicted in FIG. 2A taken along the line A-A. FIG. 2B depicts the transmission of optical signal 215 from optical signal transmission element 210 to optical signal reception element 220 through reinforcing element 140 in substrate 110, as such elements were described above in conjunction with FIG. 1 and FIG. 2B. Reinforcing element 140 includes at least one optical waveguide 145. The optical waveguide 145 is not separately depicted in FIG. 2B, but is included in reinforcing element 140 as was described above in conjunction with FIG. 1.

FIG. 2B depicts the optical signal transmission element 210 and optical signal reception element 220 as extending only partially through the thickness of substrate 110. Specifically, as depicted in FIG. 2B, the optical signal transmission element 210 and optical signal reception element 220 are disposed in separate holes formed in substrate 110 and rest on a remaining portion of resin material 130. However, the optical signal transmission element 210 and optical signal reception element 220 may mounted or otherwise disposed on the substrate 110 by other means. For example, the optical signal transmission element 210 and optical signal reception element 220 may extend through the entire thickness of substrate 110 and rest on another circuit board or substrate on which substrate 110 has been mounted. Likewise the manner of mounting the optical signal transmission element 210 and optical signal reception element 220 is not limited. For example, and without limitation, the transmission element 210 and reception element 220 may be soldered, glued, taped, clamped, attached with screws, bolts, or other physical connectors. It is not required that the optical signal transmission element 210 and optical signal reception element 220 be mounted in the same manner.

The transmission distance of the optical signal 215 through reinforcing element 140 may be any distance at which the optical signal retains sufficient information for determining the intended signal content. Other than being limited by the physical dimensions of the substrate 110, the transmission distance may be affected by such factors as signal transmission efficiency of the optical waveguide 145, strength of the initial signal supplied to or generated by transmission element 210, signal coupling efficiency between transmission element 210 and the optical waveguide 145, signal coupling efficiency between optical waveguide 145 and reception element 210, sensitivity of the reception element 220. Considering such factors, a transmission distance of at least 1 cm to 50 cm would be obtainable.

FIGS. 2A and 2B depict transmission of optical signal 215 through a portion of reinforcing element 140 passing underneath a device component 150. As discussed, various means for attaching or mounting device components are known in the art. Some existing techniques include through-hole technology, which involves drilling holes through the printed circuit board. Such mounting methods could disrupt or sever one or more optical waveguides 145 included in reinforcing element 140 and preclude transmission of a signal through those portions of substrate 110 in which certain device components have been mounted. However, to the extent at least some optical waveguides 145 remain undisrupted, the undisrupted optical waveguides 145 can transmit optical signals. Specific designs for printed circuit boards incorporating reinforcing elements 140 could consider these factors when laying out components. For example, through-hole mounted device components 150 can be positioned outside of an intended optical signal transmission lane. On the surface above the optical transmission lane only (or at least preferentially) surface-mount device components 150 might be positioned.

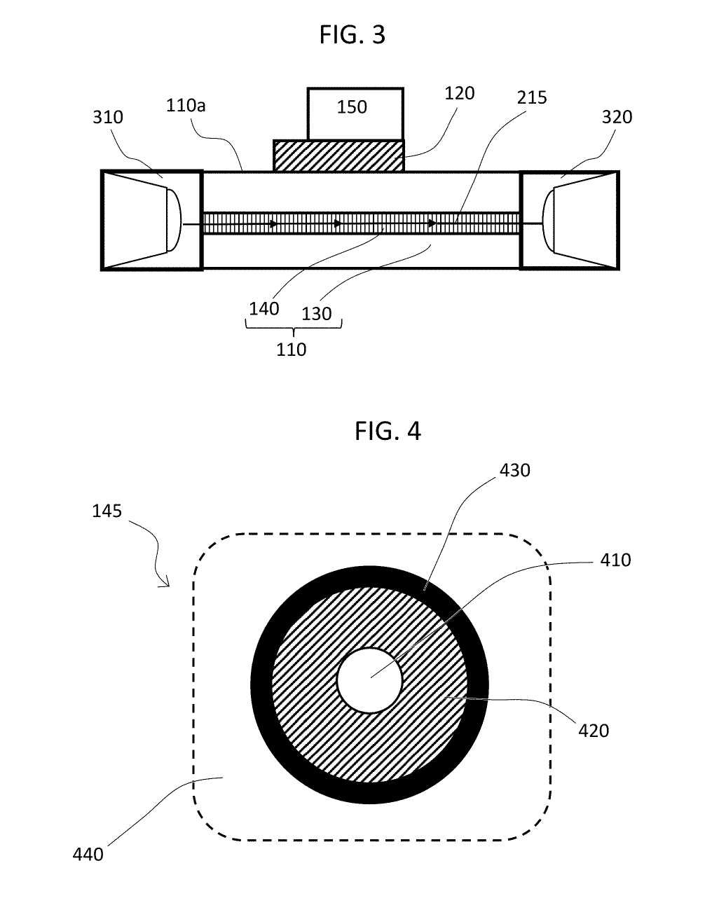

FIG. 3 depicts another variant of an electronic device incorporating an optical waveguide in a reinforcing element of a circuit board. In FIG. 3, an optical signal transmission element 310 and an optical signal reception element 320 are provided on opposing edges of substrate 110. The transmission element 310 is otherwise similar to transmission element 210 described above, and the optical signal reception element 320 is otherwise similar to reception element 210 described above. The optical signal 215 is again transmitted along optical waveguide(s) 145 (not separately depicted in FIG. 3) within reinforcing element 140 embedded within resin material 130 in substrate 110. A conductive layer 120 and a device component 150 are disposed on substrate 110. Mounting or connection of optical signal transmission element 310 and optical signal reception element 320 to substrate 110 can be made by various means, such as adhesive, soldering, or the like and with or without mounting brackets connected to substrate 110.

In other variations, an outer-edge mounted transmission element 310 can be coupled to an upper surface mounted reception element 220. Likewise, an outer-edge mounted reception element 320 can also be coupled to an upper surface mounted transmission element 210.

FIG. 4 depicts an optical waveguide 145 according to an embodiment in an end-on, cross-sectional view. In general, optical waveguide 145 is a dielectric waveguide which relies on total internal reflection to propagate light along a longitudinal direction (end-to-end direction). The specific example of optical waveguide 145 depicted in FIG. 4 is a cylindrical, fiber-like element, but the optical waveguide 145 can be other than cylindrical-shaped, for example, the cross-section might be oval, oblong, or rectangular rather than circular. In some examples, the optical waveguide 145 may be a ribbon-like element rather than a cylindrical fiber-like element.

Optical waveguide 145 includes a core 410 and a cladding 420. Optical fibers are often made of silica or glass cores and claddings, but plastic optical fibers are also known. An outer layer 430 is included in this example, but is optional. The outer layer 430 can be a protective coating or covering for the interior components of the waveguide. A component of the outer layer 430 may be provided to promote adhesion between optical waveguide 145 and a material such as resin material 130 or a resin precursor 440 to resin material 130.

A resin precursor 440 may be optionally provided on optical waveguide 145. Resin precursor 440 can be supplied for use in a circuit board fabrication process in which optical waveguide 145 is first coated with resin precursor 440 and then precursor-coated optical waveguide is used to form substrate 110 by a lamination or molding process or the like. During this fabrication process, the resin precursor 440 coated on the optical waveguide 145 forms and/or binds with resin material 130. In such instances, the optical waveguide 145 coated with precursor 440 may be referred to as a “pre-preg” material or a “pre-preg” fiber.

In general, optical signal propagation (through internal reflection) requires the core 410 to have a higher refractive index than the cladding layer 420. In some examples, the refractive index different between core 410 and cladding 420 may be abrupt. In other examples, the refractive index difference between core 410 and cladding 420 may be graded or gradual. The total difference in refractive index between core 410 and cladding 420 may be relatively small, for example, less than one percent of the core's refractive index in some embodiments.

Note the dimensions of FIG. 4 are not intended to be to scale. In general, the diameter of the core 410 depends on the specifics of the material(s) selected, the intended wavelength(s) of optical signal(s) to be transmitted by the waveguide, and intended operation of the waveguide (e.g., single mode or multimode transmission). A multimode optical fiber typically may have a core diameter that is in a range of 50 to 500 microns. A single-mode optical fiber for transmitting near-infrared light (commonly used in telecommunications applications) may have a core diameter of 8 to 10 microns and cladding layer with an outer diameter of 100 to 150 microns. Such a single-mode fiber is often formed using a doped silica core and an undoped silica cladding layer. In other optical fiber examples, either or both of the core and the cladding may be doped silica materials. A difference in doping of the silica core as compared to the silica cladding can be used to provide the difference in the refractive index necessary for optical signal propagation. Examples of possible dopants include germanium, aluminum, fluorine, and boron. In addition to silica (silicon dioxide), optical fibers can be formed with various glass materials, such as silicate glasses, fluoride glasses, phosphate glasses, chalcogenide glasses, or the like.

Printed circuit boards often incorporate a glass fiber material as reinforcing substrate component. Such reinforcing glass fibers may be woven together to form cloth-like materials. In particular, so called “E-glass” (an alumino-borosilicate glass) fibers are common in printed circuit board applications. In an example embodiment, E-glass fiber is used as optical waveguide 145. That is, an E-glass fiber serves as core 410 with cladding 420 formed by a resin coating bonded to the E-glass fiber core 410. The standard E-glass fiber cores are clad with a curable urethane acrylate material, such as an unsaturated aliphatic urethane acrylate formulation. The urethane acrylate material can be a radiation curable (e.g., ultraviolet or electron beam initiated curing) material such as Desmolux® VP. Such urethane acrylate materials might also be used to form outer layer 430 (or a portion of outer layer 430). A coupling agent can be incorporated to promote binding of the cured cladding 420 (or outer layer 430) and the resin material 130 or a precursor material to resin material 130 (such as resin precursor 440). Urethane acrylates are often used as buffer layers in optical fibers having silica cores and silica cladding layers, but in this example the urethane acrylate material forms at least a portion of a cladding layer on an E-glass fiber core. In other examples, the optical waveguide 145 may be comprised of optical fibers having a glass core 410 and a glass cladding 420 prepared by existing techniques and optionally include an outer layer (buffer layer) 430 comprising a polymeric material such as urethane acrylate material.

In some examples, an organic monomer containing hydroxyl-reactive functional groups and a separately polymerizable group would be sprayed on, or otherwise applied to, glass filaments/fibers during initial fabrication steps. An organic monomer, such as 2-isocyanatoethyl methacrylate, having an isocyanate group and a methacrylate group would react with surface hydroxyl groups of an E-glass fiber (or other silica-based glass fibers). Reaction between the isocyanate group and the surface hydroxyl groups would provide a polymerizable group (a methacrylate group) bound to the surface of the silica-based fiber via the reaction of the isocyanate group with the surface hydroxyl group. Additional, monomeric materials (which do not necessarily include an isocyanate group) might then be attached to the glass fiber via the now appended polymerizable group(s). The other material formed on the fiber in this manner may be used to form a cladding 420, an outer layer 430, and/or a resin precursor 440.

In an example in which a polyphenylene ether (PPE) resin (or resin precursor) is used for forming substrate 110 in a “pre-preg” fabrication process, free radical initiators included with the PPE resin to promote curing of the PPE can also initiate reactions with the available polymerizable groups attached to the optical fiber. As such, the glass fiber may be covalently bonded to the PPE resin via the polymerizable group (e.g., methacrylate end groups) attached to the fiber. While the acrylate polymerizable groups bound to the glass fiber could polymerize with other acrylate groups on other fibers, or other components in the pre-preg resin (for example, additional “binder” components), even a relatively small number of reactions between the PPE resin and the acrylate polymerizable group would be sufficient to bind the glass fiber to the pre-preg resin

In some methods of making a printed circuit board, the reinforcing material(s) may be coated with uncured or partially cured resin material and this resin-coated reinforcing material may subsequently pressed or cured to form the circuit board substrate with or without additional resin material being supplied in the process. When pre-coated with resin, reinforcing materials may be referred to as “pre-preg” (short for “pre-impregnated”) materials. These pre-preg materials, when incorporating an optical waveguide 145 or the like, can be used to form a circuit board substrate 110 or the like, which can be used in a printed circuit board 100 or the like. That is, the pre-preg materials ultimately form a reinforcing element 140 in a circuit board substrate 110.

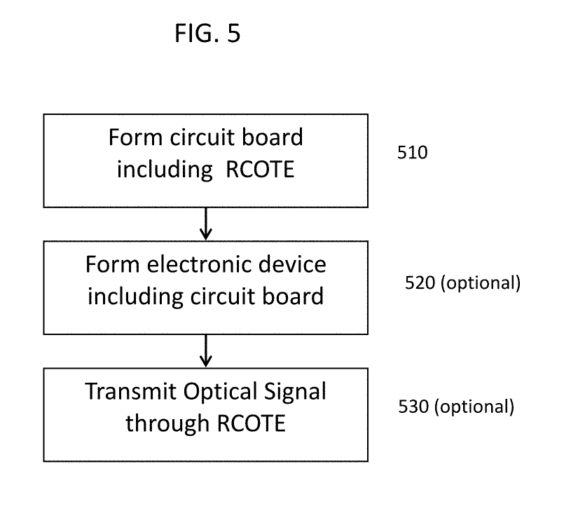

FIG. 5 depicts aspects of method comprising forming a circuit board including a reinforcing component with an optically transmissive element (RCOTE) (element 510). In element 510, a circuit board substrate is formed by embedding a reinforcing component in a resin. The reinforcing component includes an optical transmissive element through which an optical signal or signals can be transmitted. For example, the circuit board substrate can be a substrate 110, the resin can be a resin material 130, the reinforcing component can be a reinforcing element 140, and the optical transmissive element can be an optical waveguide 145, as such were described above. The reinforcing component provides structural strength to the circuit board substrate.

The method for forming the circuit board may include forming “pre-preg” materials with optical fibers having an E-glass core and a polymeric cladding layer. The polymeric cladding layer may comprise urethane acrylate materials.

Forming the circuit board may also include formation and/or patterning of conductive layers, such as conductive layer 120. Various device components 150 may be mounted to the circuit board substrate. Optical signal transmitter/receiver components are also mounted or otherwise connected to the circuit board substrate. For example, optical signal transmission elements (210 or 310) and optical signal reception element (220 or 320) may be provided and coupled to the optically transmissive element in the reinforcing component.

In an optional aspect, the circuit board previously formed in element 510 can be used to form an electronic device (element 520). Here, formation of an electronic device may include placing the circuit board in a housing, installing the circuit board in a slot connector, connecting the circuit board to other circuit boards, making external wiring connections to device components 150 on the circuit board, connecting an external optical fiber cable to one or both of the optical transmitter/receiver components, or the like.

In another optional aspect (element 530), the electronic device formed in element 520 can be used so as to transmit an optical signal through the optically transmissive element in the reinforcing component of the circuit board formed in element 510.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing is directed to embodiments of the present invention, other and further embodiments of the invention may be devised without departing from the basic scope thereof, and the scope thereof is determined by the claims that follow.

1-9. (canceled)

10. A circuit board substrate, comprising:
a resin material; and
a reinforcing element embedded in the resin material and comprising an optical fiber,
wherein the optical fiber has an alumino-borosilicate glass core and a polymeric cladding layer.

11. The circuit board of claim 10, wherein the polymeric cladding layer comprises a urethane acrylate.

12-17. (canceled)

18. An electronic device, comprising:
a circuit board having a device component mounted thereon, the circuit board comprising:
a resin material; and
a reinforcing element embedded in the resin material and including an optical fiber;
an optical signal transmitter mounted to the circuit board and coupled to a first end of the optical fiber; and
an optical signal receiver mounted to the circuit board and coupled to a second end of the optical fiber,
wherein the optical fiber has an alumino-borosilicate glass core and a urethane acrylate cladding layer.

19. (canceled)

20. A method, comprising:
forming a circuit board substrate by embedding a reinforcing element in a resin material, the reinforcing element including an optical fiber,
wherein the optical fiber has an alumino-borosilicate glass core and a urethane acrylate cladding layer.
